(19) United States
(12) Patent Application Publication
(10) Pub. No.: US 2024/0238695 A1
(43) Pub. Date: Jul. 18, 2024

(54) MODULAR CRYSTALLISATION DEVICE

(71) Applicant: COOL SEPARATIONS B.V., Poortugaal (NL)

(72) Inventors: Dirk Cornelis NOOTENBOOM, Rhoon (NL); Jacob VAN SPRONSEN, Noordwijk (NL)

(21) Appl. No.: 18/558,814

(22) PCT Filed: May 5, 2022
(86) PCT No.: PCT/NL2022/050245

§ 371 Date: Nov. 3, 2023

(30) Foreign Application Priority Data
May 5, 2021 (NL) 2028154

(51) Int. Cl. B01D 9/00; B01D 9/02

(52) U.S. Cl. CPC B01D 9/0013; B01D 9/02; B01D 2009/0086

(57) ABSTRACT

A system is provided for performing crystallisation by cooling, comprising two crystallisation units, each of the two crystallisation units comprising a cooling body with a crystallisation surface for forming crystals on, and a scraper unit, comprising a scraping member arranged to be moved over the crystallisation surface for scraping crystals from the crystallisation surface and a scraper actuator for moving the scraping member over the crystallisation surface, wherein the scraper actuator of a first of the two crystallisation units can be actuated independently from a scraper actuator of a second of the two crystallisation units.

### BACKGROUND

The aspects and embodiments thereof relate to the technical field of devices for crystallisation by cooling.

### BACKGROUND

Crystallisation is a process in which a solid is formed, for example from a solution of salt in water. Crystallisation may be performed by heating the solution, thereby evaporating the water, or by cooling. Two examples of crystallisation by cooling are eutectic freeze crystallisation and cooling crystallisation.

Eutectic Freeze Crystallisation (EFC) is a process wherein ice and salt (i.e. a compound) are separated from a salt-water mixture. The salt-water mixture is held at an eutectic point, where an equilibrium exists between ice, salt and a solution with a specific concentration. This specific concentration is called the eutectic concentration and the temperature at which this equilibrium is found is the eutectic temperature.

A cooled disc column crystallizer may be used for forming ice and salt crystals in the salt-water mixture. A typical cooled disc column crystallizer comprises a columnar liquid container wherein multiple disks are positioned. The disks are cooled, and as such ice and salt crystals form on the outer surface of the disks. Scrapers are moved over the outer surface of the disks to prevent scaling and to improve heat transfer between the salt-water mixture and the disks. A feed stream enters the crystallizer at the centre of the column. Liquid as well as solids are axially transported through orifices in the cooling disks.

Another apparatus and method for separation and purification of a liquid mixture by crystallization is described in U.S. Pat. No. 2,898,271. Herein, a apparatus is described comprising a plurality of small diameter columns each comprising of a scraped chiller of crystallizer tube and a screw of a decreasing pitch turning the a porous cylinder. This apparatus is used to separate and purify waxy materials.

Cooling crystallisation is a process wherein crystal growth is promoted in a supersaturated aqueous solution of a compound. By virtue of the cooling crystallisation process, spontaneous formation of new crystals in the solution may be induced, and/or growth of existing crystals may be induced.

### SUMMARY

In the known cooled disc column crystallizers, the scrapers are formed as arms radially extending from a shaft. The shaft is oriented perpendicular to the disks, and rotated around a rotation axis which is parallel to an axial direction of the shaft. All the scrapers are connected to a single shaft, which shaft extends through through-holes through the disks.

It has been observed that the scrapers have to be replaced, as they wear while in use. In particular, it has been observed that wear occurs due to ice crystals forming on the cooling disks. When a scraper has to be replaced, the known cooled disc column crystallizers is temporarily out of order, which causes undesired down-time.

In particular when ice crystals are formed on a crystallisation surface, it is preferred to prevent too many crystals to be formed as ice crystals have a high hardness. If too many crystals are formed, the heat transfer between the cooling body and the compound-water mixture (i.e. an aqueous solution) is reduced. Furthermore, it may become impossible to move the scraping member over the crystallisation surface if a layer of crystals on the crystallisation becomes too thick.

It is preferred to reduce down-time of devices used in a crystallisation by cooling process. In general, throughout the present disclosure, the terms “crystallisation” and “crystallisation by cooling” will be used for any one of a cooling crystallisation process, freeze crystallisation process, eutectic freeze crystallisation process, or any other process in which crystals are formed in a solution and/or grown on a crystallisation surface. As such, a system for performing crystallisation by cooling may for example be a system for performing crystallisation or a system for performing cooling crystallisation.

A first aspect provides a system for performing crystallisation by cooling, comprising two crystallisation units, each of the two crystallisation units comprising: a cooling body with at least one crystallisation surface for forming crystals on, optionally a cooling fluid distribution network for circulating cooling fluid through the cooling body, and a scraper unit, the scraper unit comprising a scraping member arranged to be moved over the crystallisation surface for scraping crystals from the crystallisation surface and a scraper actuator for moving the scraping member over the crystallisation surface, wherein the scraper actuator of a first of the two crystallisation units can be actuated independently from a scraper actuator of a second of the two crystallisation units.

By being able to actuate the scraper actuators of the crystallisation units independently, a first crystallisation unit may be removed from the system without requiring a scraper unit of a second crystallisation unit to be stopped. Independence may be obtained when each scraper actuator is connected to a separate motor or drive, or by using a single motor or drive and one or more clutches to connect and disconnect the single motor or drive from a particular scraper unit without having to stop the other scraper unit from moving.

With the independent scraper actuators per crystallisation unit, a modular system for performing crystallisation by cooling may be obtained. Modular implies that selectively, one or more crystallisation units may be placed, replaced, or removed, temporarily or permanently in the system. As a particular option, the crystallisation units in the system may be similar or identical such that they may be interchangeable.

The scraper actuator for example is or comprises a cog, gear, sprocket or pulley to which a chain or belt can be connected, which chain or belt can be driven by a motor. By using a chain, a belt, a drive shaft, or any other means for transferring rotational energy between the motor and the actuator, the motor may be positioned at a distance from the scraper actuator. The scraper actuator may as such in use be submerged in the liquid, while the motor may be positioned outside the liquid. In general, any component which is submerged in a liquid may be understood as generally being in contact with the liquid.

A crystallisation unit may comprise one or more scraping members. A scraping member may comprise a sharpened edge or knife edge, which in use scrapes over the crystallisation surface. By scraping over the crystallisation surface, crystals such as ice crystals or salt crystals or any other precipitated compound may be removed or dislodged from the crystallisation surface. Scraping may wear a scraping member, which may in turn require regular maintenance, servicing or replacement of a scraping member. Part of the scraping member may be replaceable. For example, a knife, blade or other sharpened element comprised by the scraping member may be replaceable.

It will be understood that a system for performing crystallisation by cooling may comprise more than two crystallisation units, the scraper actuators of which may also be actuated independently from scraper actuators of the other crystallisation units. It will also be understood that a scraper unit may comprise more than one scraping member.

In use, the cooling body is cooled to a temperature below the temperature of the liquid it is at least partially submerged in. For controlling the temperature of the cooling body, a cooling fluid distribution network for circulating cooling fluid through the cooling body may be provided. The cooling fluid distribution network may comprise one or more conduits extending through the cooling body such that cooling fluid may be circulated through the cooling body. Such conduits may for example be formed by grooves, cavities, or other hollow sections in the cooling body. Alternatively, other means for cooling the cooling body may be used, using for example at least one of conduction, convection, and radiation for removing heat from the cooling body.

In use, the temperature of the cooling body, and in particular the temperature of a crystallisation surface of the cooling body, may be below an eutectic temperature of the liquid in which the cooling body is positioned. The liquid may for example be a salt-water mixture or an aqueous solution of another compound, in particular a supersaturated solution of one or more salts in water. For cooling crystallisation and freeze crystallisation, different temperatures of the cooling body may be required.

The rotation axis of the scraper member of a first of the two crystallisation units may be aligned or at least parallel with the rotation axis of the scraper member of a second of the two crystallisation units.

As a particular option, each of the two crystallisation units may comprise a motor for actuating their respective scraper actuator, which motor may for example be an electric motor. The respective motor may be connected to its respective scraper actuator via a belt, a chain or a drive shaft.

The motor of each of the two crystallisation units may be connected to the frame of the respective crystallisation unit outside the volume for holding the liquid. As such, the motor may not necessarily be liquid-tight.

A system according to the first aspect may further comprise a liquid container comprising a volume for holding a liquid. Two crystallisation units of the system may both comprise a mounting frame arranged to be mounted to the liquid container such that the cooling body can be positioned in the volume for holding the liquid. In particular, the two crystallisation units are mounted to the same liquid container, and the cooling bodies of the two crystallisation units are positioned in the same volume for holding the liquid. A liquid container may have a top opening which allows part of a crystallisation unit to be positioned in the liquid container via the top opening.

The scraping members of the two crystallisation units may be arranged to be rotated relative to their associated cooling body by virtue of a rotation of the associated scraper actuator around a rotation axis. For example, a first scraping member of a first of the two crystallisation units may be arranged to be rotated relative to the cooling body of the first of the two crystallisation units.

The rotation axis of the scraper actuator of a first of the two crystallisation units may be aligned with or may be parallel to the rotation axis of the scraper actuator of a second of the two crystallisation units. In use, the rotation axes may be substantially horizontal.

A second aspect provides a method for servicing a system for performing crystallisation by cooling comprising two or more crystallisation units, the method comprising the steps of removing a first of the two or more crystallisation units from a liquid container holding a liquid, servicing the first of the two crystallisation units, and after the servicing, re-submerging at least part of the first of the two crystallisation units back into the liquid held in the liquid container, wherein during the removing and the servicing of the first of the two crystallisation units, a second of the two crystallisation unit is kept submerged in the liquid held in the liquid container.

By keeping at least part the second of the two crystallisation units submerged in the liquid, the crystallisation process may be continued during the servicing of the first crystallisation unit. Hence, down-time of the system may be reduced or even prevented.

A particular example of servicing comprises replacing a scraping member of a scraping unit of the first of the two crystallisation units. The scraping members may wear in use, and therefore may have to be replaced regularly.

Preferably, during the removing and the servicing of the first of the two crystallisation units, a scraper member of the second of the two crystallisation unit may be moved over a crystallisation surface of a cooling body of the second of the two crystallisation units. When the scraper member of the second of the two crystallisation unit is moved over the crystallisation surface of the cooling body of the second of the two crystallisation units, the second crystallisation unit may still be in use. As such, excess crystallisation on the crystallisation surface of the cooling body of the second of the two crystallisation units may be prevented or at least reduced.

Moving the scraper member of the second of the two crystallisation unit over the crystallisation surface of the cooling body of the second of the two crystallisation units may for example be done by rotating the scraper member around a rotation axis relative to the cooling body.

The method according to the second aspect may in particular be applied to any embodiment of the system according to the first aspect.

A third aspect provides a crystallisation unit, comprising a cooling body with a first crystallisation surface for forming crystals on, an optional cooling fluid distribution network for circulating cooling fluid through the cooling body, and a first scraper unit, comprising a first scraper frame holding a first scraping member arranged to be moved over the first crystallisation surface for scraping crystals from the first crystallisation surface and a first scraper actuator for rotating the first scraper frame relative to the cooling body around a first rotation axis, wherein the first scraper frame is at a first radius at or near the first rotation axis coupled to the cooling body, and the first scraper frame is at a second radius coupled to the cooling body via a restriction member, which second radius is larger than the first radius.

The crystallisation unit according to the third aspect is in particular for use in a system for performing crystallisation by cooling according to the first aspect, but may also be used as a single crystallisation unit without a second crystallisation unit. It will hence be understood that the third aspect may be independent of the first aspect. However, it should also be understood that options disclosed in conjunction with the third aspect may be readily applied to one or more crystallisation units used in embodiments of the system according to the first aspect. Hence, a crystallisation unit according to the third aspect may be serviced according to part of the method according to the second aspect.

In use, when a scraping member is moved over a crystallisation surface and scraping crystals of the crystallisation surface, the scraping member may be pressed, bent, deflected or deformed in general away from the crystallisation surface. This may in particular occur with ice and salt crystals with a high hardness, and/or which require a large force to become dislodged or scraped from the crystallisation surface.

When the first scraper frame, which holds the scraping member, is at a first radius and a second radius coupled to the cooling body, deformation of the scraping member during scraping may be reduced. In particular, when the first scraper frame is only coupled to the cooling body at or near the rotation axis, the scraper member and/or the scraper frame may behave as a cantilever. With an increased arm of the cantilever away from the rotation axis, the deformation due to bending increases.

When the scraper frame is also coupled to the cooling body at the second radius which is larger than the first radius, the deformation may decrease. This in turn may allow for better scraping, less wear, and/or may allow a larger scraper frame to be used in conjunction with a larger crystallisation surface, which in turn may result in a higher crystallisation yield and/or general higher efficiency of the crystallisation unit.

A scraping member may extend at least partially radially relative to the first rotation axis between the first radius and the second radius. As such, the scraping member may be restricted from bending away from the crystallisation surface during scraping. In other words, the scraping member may now have no free end which may be bent away from the crystallisation surface during scraping. Part of the scraping member may extend beyond the first radius towards the first rotation axis and/or beyond the second radius away from the first rotation axis.

For increasing the surface area of the cooling body for forming crystals on, a second surface of the cooling body may be used as a crystallisation surface. This second crystallisation surface may be positioned opposite to the first crystallisation surface. When the second crystallisation surface is positioned opposite to the first crystallisation surface, a further scraping member may be required which may be moved over the second crystallisation surface.

The cooling body may in general be shaped as a cylinder, with two which are connected by a curved surface. The two substantially flat or at least convex faces may be the first crystallisation surface and the second crystallisation surface. Differently shaped cooling bodies may also be applicable, and also these preferably comprise substantially flat or convex faces as the first and/or the second crystallisation surfaces.

As an option for the first aspect and the third aspect, the first scraper frame may comprise a first ring section at or near the first radius, a second ring section at or near the second radius, and a plurality of connection sections extending between the first ring section and the second ring section.

Any cooling body may further comprises a second crystallisation surface for forming crystals on, which first and second crystallisation surface are positioned on different sides of the cooling body, and wherein the crystallisation unit further comprises a second scraper unit, comprising a second scraper frame holding a second scraping member arranged to be moved over the second crystallisation surface for scraping crystals from the second crystallisation surface and a second scraper actuator for rotating the second scraper frame relative to the cooling body. A second crystallisation surface may result in a higher crystallisation yield.

Furthermore, the cooling body may comprise a through-hole, and the first scraper frame and the second scraper frame may be connected by a connection hub extending through the through-hole. Any crystallisation unit may further comprise a bearing, which bearing allows rotation between the first scraper frame and the cooling body and between the first scraper frame and the connection hub. The bearing may be positioned at least partially in the through-hole.

As an even further option, a crystallisation unit may further comprise a mounting frame arranged to be mounted to a liquid container, and a shaft extending through the through-hole, wherein the cooling body is connected to the mounting frame via the shaft. As such, via the mounting frame, the cooling body may be connected to the liquid container.

A fourth aspect provides a method for performing crystallisation by cooling, for example using a crystallisation unit according to the first aspect or a system according to the third aspect, the method comprising the steps of submerging at least part of a cooling body in an aqueous solution of a compound such as an organic compound or a salt, allowing precipitation of water and/or said compound on the cooling body, and scraping the precipitated water, for example in the form of ice, and/or said precipitated compound, for example in the form of crystals, of the cooling body. The compound that is dissolved in water may be any type of compound that can be precipitated. For example, the compound may be a salt or an organic compound such as Vitamin C or lactose.

Thus, by virtue of the method according to the fourth aspect, crystals of the compound such as salt crystals, and/or ice crystals may be obtained from an aqueous salt solution. By virtue of removing water in the form of ice crystals, the concentration of the compound in the solution may be increased. By virtue of removing the compound in the form of crystals, for example, undesired dissolved components may be removed from a waste stream.

### BRIEF DESCRIPTION OF THE FIGURES

### In the Figures:

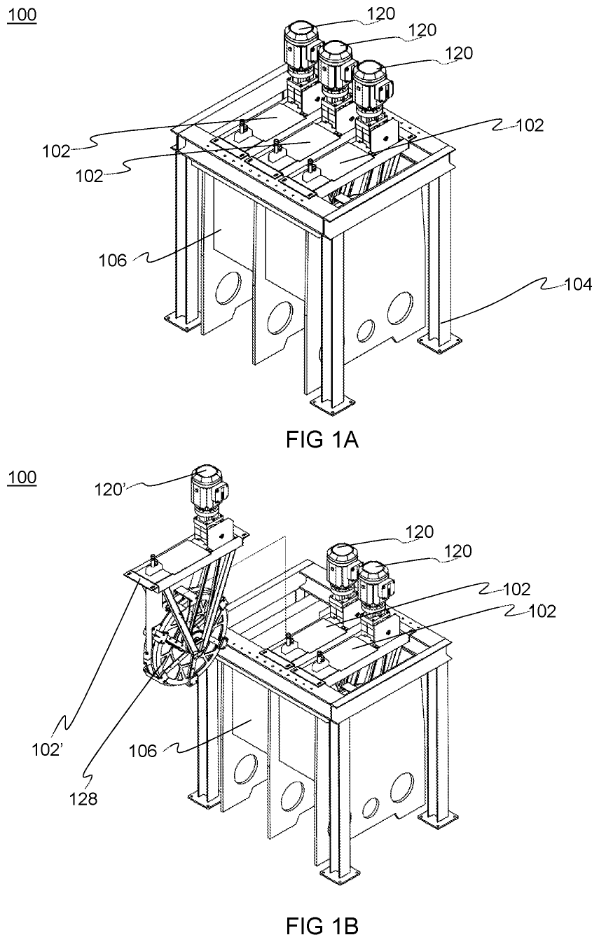

FIG. 1A shows a system for performing crystallisation by cooling;

FIG. 1B shows the system for performing crystallisation by cooling of FIG. 1A, with one of the crystallisation units removed from the system;

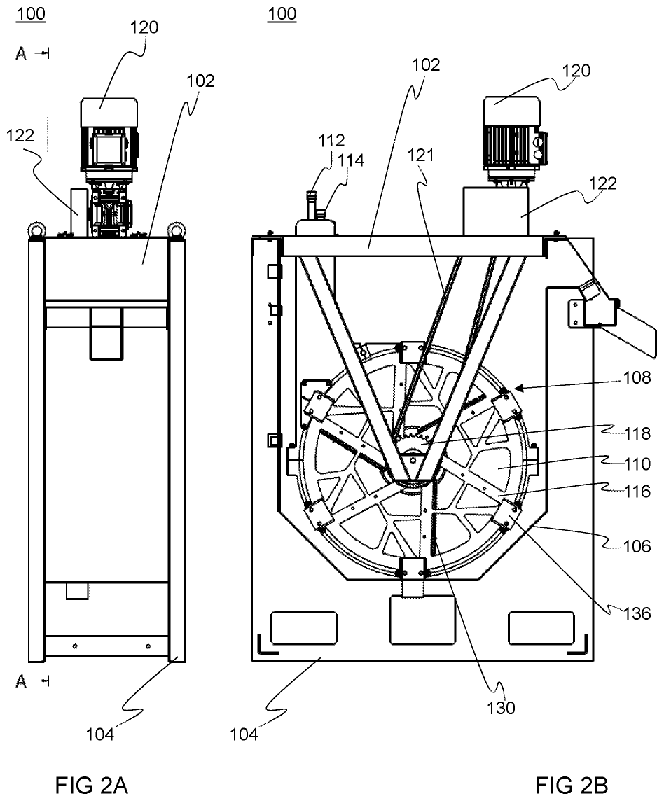

FIGS. 2A and 2B show another embodiment a system 100 for performing freeze crystallisation, respectively in a front view and a section view over the line A-A;

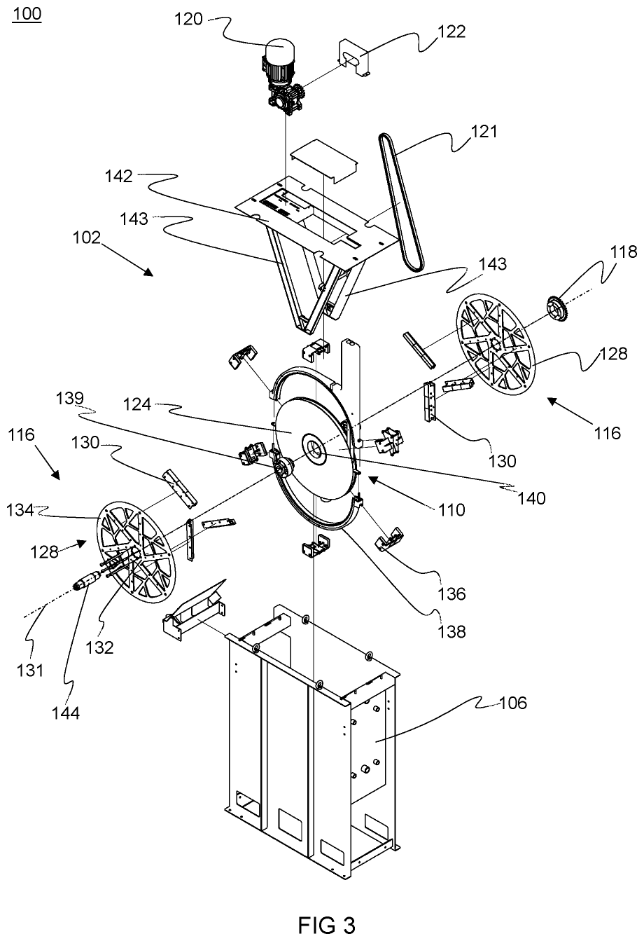

FIG. 3 shows an exploded view of the system of FIGS. 2A and 2B;

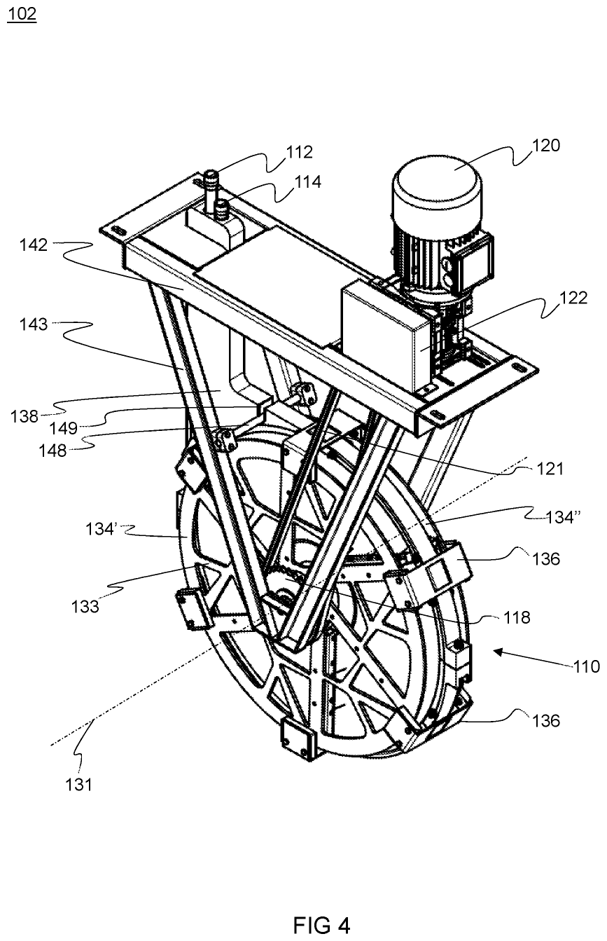

FIG. 4 shows an embodiment of a crystallisation unit; and

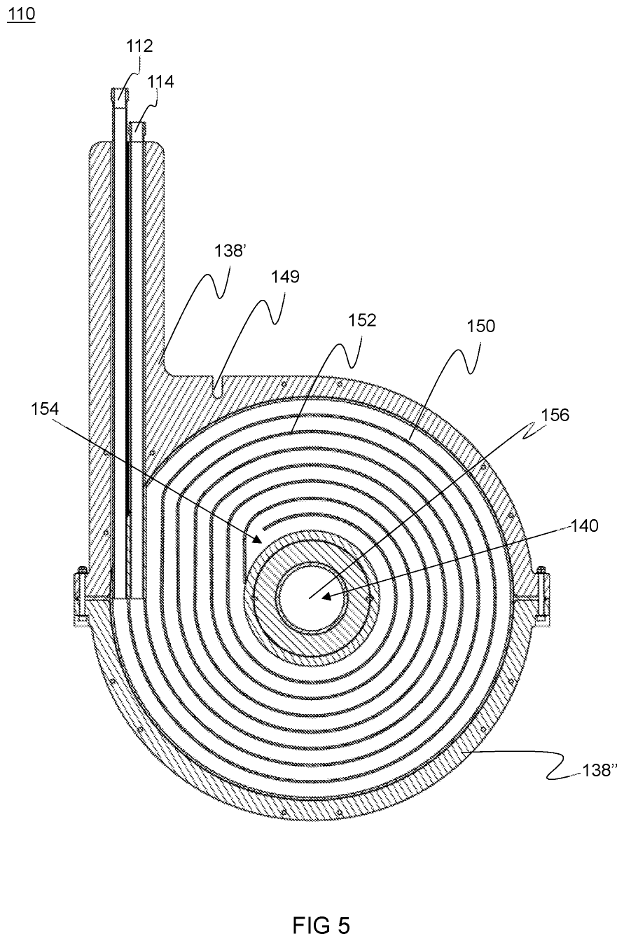

FIG. 5 shows a cross-sectional view of a cooling body.

### DETAILED DESCRIPTION OF THE FIGURES

FIG. 1A shows a system 100 for performing crystallisation by cooling, for example freeze crystallisation, comprising three crystallisation units 102 as an example of a number of crystallisation units. It will be appreciated that embodiments of the system 100 may comprise any number of crystallisation units, for example one, two, four, five or more. The system 100 comprises an optional support frame 104 for supporting the system 100 on the floor. As visible for example in FIGS. 1A and 1B, the motors 120 and optional gearboxes 102 may be positioned outside liquid container 106.

FIG. 1B shows the system 100 for performing crystallisation of FIG. 1A, with a first crystallisation units 102′ removed from the system 100. The remaining two crystallisation units 102 are still connected in the system, and may be still operational. The situation depicted in FIG. 1B may for example correspond to a situation wherein a method of servicing the system 100 is being performed.

For removing the crystallisation unit 102′ from the system 100, the crystallisation unit 102′ may be lifted out upwards in a generally vertical direction. While the first crystallisation unit 102′ is removed from the system 100, scraper actuators of the other crystallisation units 102 may still be actuated, thus independently of the scraper actuator of the first crystallisation unit 102′.

The crystallisation units 102 comprised by the system 100 of FIGS. 1A and 1B may each comprise at least one scraper unit. The scraper units may each comprise a separate scraper actuator, which may be actuated independently from scraper actuators of the other crystallisation units. Particular optional features of the scraper unit and the scraper actuator will be elaborated on below.

FIGS. 2A and 2B show another embodiment a system 100 for performing crystallisation by cooling, respectively in a front view and a section view over the line A-A. This particular embodiment of the system 100 comprises a single crystallisation unit 102, but may as all other embodiments of the system 100 comprise any number of crystallisation units.

The section view of FIG. 2B depicts the crystallisation unit 102 partially submerged or positioned in a liquid container 106 which may be at least partially filled with a liquid, for example an aqueous solution of a compound such as an organic compound or a salt. The liquid container 106 defines a volume 108 for holding a liquid. In general, inside a single volume 108 of a single liquid container 106, parts of one or more crystallisation units 102 may be positioned.

The liquid container 106 may be comprised by the system 100. A system 100 may comprise one or more liquid containers 106. The volume 108 defined or constrained by a liquid container 106 may be generally resemble a cube or a rectangular prism.

The crystallisation unit 102 comprises a cooling body 110, which is use may be partially or fully submerged in the liquid. The cooling body 110 may as an option be provided with a cooling fluid distribution network for circulating cooling fluid through the cooling body. An inlet 112 and an outlet 114 of the cooling fluid distribution network may in use be positioned outside the volume 108 of the liquid container 106, and in particular above the liquid container 106. The inlet 112 and the outlet 114 may be interchangeably used as inlet and outlet.

A particular embodiment of the cooling body 110 will be elaborated on in conjunction with FIG. 5. An outside surface of the cooling body 110 in use acts as a crystallisation surface for forming crystals on.

The crystallization unit 102 comprises a scraper unit 116 comprising one or more scraping members arranged to be moved over the crystallisation surface for scraping crystals from the crystallisation surface. The crystallization unit 102, and in particular the scraper unit, further comprises a cog 118 as a scraper actuator, which cog 118 is connected to a motor 120 via a belt 121 and an optional gear box 122. The gear box 122 may for example reduce a high rotational speed of the motor 120 to a lower rotational speed for the cog 118, thereby increasing the torque at the cog 118.

Now referring back to the system 100 of FIGS. 1A and 1B, as a further option, each crystallization unit 102 may comprise a motor 120 and optional gearbox 122. As another option, more than one crystallization unit 102 may be actuated by a single motor 120. When more than one scraper actuator is connected to a single motor or gearbox, one or more clutches may be present to selectively decouple the motor from a particular scraper actuator.

FIG. 3 shows an exploded view of the system 100 of FIGS. 2A and 2B. In particular, FIG. 3 shows an exploded view of the cooling body 110 which may comprise a for example generally disc-shaped body providing a crystallisation surface 124 for forming crystals on. Another crystallisation surface may be provided on the opposite side of the cooling body 110, which is not visible in the view of FIG. 3.

Because the embodiment of FIG. 3 comprises two crystallisation surface 124, only one of which is visible, as an option, the crystallisation unit 102 comprises two scraper units 116. In general, a scraper unit may comprise one or more components.

The scraper units 116 depicted in FIG. 3 comprise a scraper frame 128, each scraper frame 128 holding three scraping members 130. It will be understood that a scraper frame 128 may be arranged for holding any number of scraping members 130, for example one, two, four, or even five or more. In use, a scraping member 130 is arranged for scraping crystals from a crystallisation surface.

The scraper units 116 may be rotated around a rotation axis 131, for example by virtue of being connected to the cog 118. The scraping members 130 may be oriented at least partially radially relative to the rotation axis 131. During servicing of the crystallisation unit 100, one or more of the scraping members 130 may be at least partially replaced or repaired, for example when the scraping member 130 has become blunt or less sharp then preferred.

The different scraping members 130 held by a scraper frame 128 may be disposed at generally equal angles around the rotation axis 131. For example, when three scraping members 130 are used, the scraping members 130 may be placed at a 120 degree angle relative to each other.

As shown in FIG. 3, a scraper frame may be arranged as a plate element with a generally circular shape. In particular, a scraper frame 128 may comprise a first ring section 132 at or near the rotation axis or at or near a first radius relative to the rotation axis. The scraper frame 128 may further comprise a second ring section 134 at or near a second radius relative to the rotation axis 131, which second radius is larger than the first radius.

A plurality of connection sections 133, such as ribs or spokes, may extend between the first ring section 131 and second ring section 134, for example in an at least partially radial direction relative to the rotation axis 131. For example, the connection sections may be formed by milling, cutting or otherwisely removing material from the scraper frame 128. Between the connection sections, openings or through-holes may be present through which liquid may pass.

The crystallisation unit 102 shown in FIG. 3 further comprises a plurality of clamps 136 as restriction members, with which the scraper frames 134 are coupled to the cooling body 110. As an example, the crystallisation unit 102 comprises six clamps 136, but other embodiments may comprise any other number of clamps, for example one or more, three or more, five or more, or even seven or more.

The clamps 136 are connected to a cooling body support frame 138, which as for example shown in FIG. 3, may comprise multiple connectable frame parts. Referring to FIG. 5, a cooling body support frame may for example comprise a top frame part 138′ which is connectable to a bottom frame part 138″.

By virtue of the clamps 136, a movement of the outer ring 134 relative to the crystallisation surface 124 is prevented or at least restricted. In use, the scraping members 130 may be oriented substantially parallel to the crystallisation surface 124. Thus, by virtue of the clamps 136, movement of the scraping members 130 away from the crystallisation surface 124 may be prevented or at least restricted. It will be understood that a rotation of the scraper frames 134 relative to the cooling body 110 is allowed by the clamps 136. For example, a surface of the scraper frames in use slides against a surface of the clamps.

The different clamps 136 may be disposed at generally equal angles around the rotation axis 131. For example, when six clamps 136 are used, the clamps 136 may be placed at a 60 degree angle relative to each other.

FIG. 4 shows an embodiment of a crystallisation unit 102, which for example may be comprised by a system for performing crystallisation by cooling. As shown in FIG. 4, a clamp 136 may couple both a first outer ring 134′ and a second outer ring 134″ on an opposite side of the cooling body 110 to the cooling body 110. A clamp 136 may for example comprise a generally U-shaped cross-section.

As for example depicted in FIG. 3, the cooling body 110 may comprise a through-hole or opening 140 at or near the rotation axis 131. A shaft 144 extends through the opening 140, which shaft is connected to the mounting frame 142 via two extended mounting frame parts 143. The mounting frame parts 143 and the mounting frame 142 may generally resemble a triangle in a side view, with the point pointing downward, and the rotation axis 131 at or near distal ends of the mounting frame parts 143.

In use, the shaft 144 as well as the cooling body 110 may be static, i.e. not rotating. To allow rotation of the scraper frames 134 relative to the cooling body 110, one or more bearings may be comprised by the crystallisation unit 102. To couple rotation of the two scraper frames 134, the two scraper frames 134 may be connected or coupled through the opening 140 as a through-hole.

As a particular option, a connection hub 139 may be used to connect the two scraper frames through the opening 140. The connection hub 139 extends through the opening 140. The bearing or bearings may be positioned on or around the connection hub 139, and between the connection hub 139 and the scraper frames 128. The cog 118 may be connected to one of the scraper frames 128. The shaft 144 may axially extend beyond the connection hub 139, in particular on both sides of the connection hub 139. As a further option, the shaft 144 may extend through the connection hub 139, which connection hub 139 hence may comprise a through-hole.

As depicted in FIG. 4, a blocking member 148 may be used to prevent or at least restrict rotation of the cooling body support frame 138 relative to the mounting frame 142 around the rotation axis 131. The blocking member 148 may protrude through a slot 149 in the cooling body support frame 138, which slot is shown in FIG. 5.

In general, the rotation axis 131 may be substantially parallel to the horizon. A rotation axis of the motor 120 may be substantially parallel to the horizon, or may as another option be substantially parallel to gravity. The gearbox 122 may be used to allow a misalignment of the rotation axis of the motor and the scraper actuator 118.

FIG. 5 shows a cross-sectional view of an embodiment of a cooling body 110, which cooling body may be comprised by any embodiment of a crystallisation unit, for example any of the crystallisation units depicted in FIGS. 1-4.

The cooling body 110 comprises a fluid distribution network through the cooling body 110, which may be formed as a hollow chamber 150. Inside the hollow chamber 150, one or more fluid guidance members 152 may be positioned to guide a flow of fluid through the cooling body 110.

To promote a uniform temperature of the cooling body 110, the one or more fluid guidance members 152 may be formed and positioned such that two spiralled paths are formed. A first spiralled path is provided between the inlet 112 and a turnaround point 154 at or near a centre 156 of the cooling body. A second spiralled path is provided in fluid communication with the first spiralled path, and between the turnaround point 154 and the outlet 114. The first spiralled path and the second spiralled path are wrapped around each other.

It will be understood that the embodiments depicted in the figures are merely non-limitative options of embodiments of the different aspects. In the description above, it will be understood that when an element is referred to as being connect to another element, the element is either directly connected to the other element, or intervening elements may also be present. Also, it will be understood that the values given in the description above, are given by way of example and that other values may be possible and/or may be strived for.

It is to be noted that the figures are only schematic representations of embodiments that are given by way of non-limiting examples. For the purpose of clarity and a concise description, features are described herein as part of the same or separate embodiments, however, it will be appreciated that the scope of the disclosure may include embodiments having combinations of all or some of the features described.

The word ‘comprising’ does not exclude the presence of other features or steps. Furthermore, the words ‘a’ and ‘an’ shall not be construed as limited to ‘only one’, but instead are used to mean ‘at least one’, and do not exclude a plurality.

In general, in the figures, similar components or feature are provided with similar reference numerals. However, for clarity and conciseness of the figures, not all components may have been provided with reference numerals in all of the figures. Embodiments with less features than shown in the figures are also envisioned, at fall within the scope of the different aspects.

1. A system for performing crystallisation by cooling, comprising:
two crystallisation units, each of the two crystallisation units comprising:
a cooling body with a crystallisation surface for forming crystals on; and
a scraper unit, comprising a scraping member arranged to be moved over the crystallisation surface for scraping crystals from the crystallisation surface and a scraper actuator for moving the scraping member over the crystallisation surface, wherein the scraper actuator of a first of the two crystallisation units can be actuated independently from the scraper actuator of a second of the two crystallisation units.

2. The system according to claim 1, further comprising a liquid container comprising a volume for holding a liquid, and wherein the two crystallisation units both comprise a mounting frame arranged to be mounted to the liquid container such that the cooling body can be positioned in the volume for holding the liquid.

3. The system according to claim 1, wherein the scraping members of the two crystallisation units are arranged to be rotated relative to their associated cooling body by virtue of a rotation of the scraper actuator around a rotation axis.

4. The system according to claim 3, wherein the rotation axis of the scraper actuator of a first of the two crystallisation units is aligned with the rotation axis of the scraper actuator of a second of the two crystallisation units.

5. The system according to claim 3, wherein each of the two crystallisation units comprises a motor for actuating their respective scraper actuator.

6. The system according to claim 5, wherein the respective motor is connected to its respective scraper actuator via a belt, a chain, or a drive shaft.

7. The system according to claim 5, further comprising a liquid container comprising a volume for holding a liquid, wherein the two crystallisation units both comprise a mounting frame arranged to be mounted to the liquid container such that the cooling body can be positioned in the volume for holding the liquid; and wherein the motor of each of the two crystallisation units is connected to the mounting frame of the respective crystallisation unit outside the volume for holding the liquid.

8. The system according to claim 3, wherein the rotation axis around which the scraper actuator is arranged to rotate is a horizontal axis in use.

9. The system according to claim 1, wherein the crystallisation surfaces are substantially flat or convex.

10. A method of servicing a system for performing crystallisation by cooling, the system comprising two crystallisation units, the method comprising:
removing a first of the two crystallisation units from a liquid container holding a liquid;
servicing the first of the two crystallisation units; and
after the servicing, re-submerging at least part of the first of the two crystallisation units back into the liquid held in the liquid container,
wherein during the removing and the servicing of the first of the two crystallisation units, at least part of a second of the two crystallisation units is kept submerged in the liquid held in the liquid container.

11. The method according to claim 10, wherein the servicing comprises replacing a scraping member of a scraping unit of the first of the two crystallisation units.

12. The method according to claim 10, wherein during the removing and the servicing of the first of the two crystallisation units, a scraper member of the second of the two crystallisation units is moved over a crystallisation surface of a cooling body of the second of the two crystallisation units.

13. The method according to claim 10, wherein each of the two crystallisation units comprises:
a cooling body with a crystallisation surface for forming crystals on; and
a scraper unit, comprising a scraping member arranged to be moved over the crystallisation surface for scraping crystals from the crystallisation surface and a scraper actuator for moving the scraping member over the crystallisation surface, wherein the scraper actuator of a first of the two crystallisation units can be actuated independently from the scraper actuator of a second of the two crystallisation units.

14. A crystallisation unit comprising:
a cooling body with a first crystallisation surface for forming crystals on; and
a first scraper unit, comprising a first scraper frame holding a first scraping member arranged to be moved over the first crystallisation surface for scraping crystals from the first crystallisation surface and a first scraper actuator for rotating the first scraper frame relative to the cooling body around a first rotation axis;
wherein
the first scraper frame is at a first radius at or near the first rotation axis coupled to the cooling body; and
the first scraper frame is at a second radius coupled to the cooling body via a restriction member, which second radius is larger than the first radius.

15. The crystallisation unit according to claim 14, wherein the first scraping member at least partially radially extends relative to the first rotation axis between the first radius and the second radius.

16. The crystallisation unit according to claim 14, wherein the first scraper frame comprises:
first ring section at or near the first radius;
a second ring section at or near the second radius; and
a plurality of connection sections extending between the first ring section and the second ring section.

17. The crystallisation unit according to any of the claim 14, wherein the cooling body further comprises a second crystallisation surface for forming crystals on, wherein the first and second crystallisation surfaces are positioned on different sides of the cooling body, and wherein the crystallisation unit further comprises a second scraper unit, comprising a second scraper frame holding a second scraping member arranged to be moved over the second crystallisation surface for scraping crystals from the second crystallisation surface and a second scraper actuator for rotating the second scraper frame relative to the cooling body.

18. The crystallisation unit according to claim 17, wherein the cooling body comprises a through-hole, and the first scraper frame and the second scraper frame are connected through the through-hole by a connection hub.

19. The crystallisation unit according to claim 18, further comprising a bearing, wherein the bearing allows rotation between the first scraper frame and the cooling body and between the first scraper frame and the connection hub.

20. The crystallisation unit according to claim 18, further comprising a mounting frame arranged to be mounted to a liquid container, and a shaft extending through the through-hole, wherein the cooling body is connected to the mounting frame via the shaft.

21. A method for performing crystallisation by cooling comprising:
submerging at least part of a cooling body in an aqueous solution of a compound;
allowing precipitation of water and/or said compound on the cooling body; and
scraping the precipitated water and/or said precipitated compound of the cooling body.
